(19) United States
(12) Patent Application Publication
(10) Pub. No.: US 2008/0136655 A1
(43) Pub. Date: Jun. 12, 2008

(54) Over-current alerting circuit and method thereof

(75) Inventors: Tai-Shui Ho, Shanghai (CN); Shih-Kuang Tsai, Shanghai (CN); Xin-Hai Sun, Shanghai (CN)

Correspondence Address: Joe McKinney Muncy, PO Box 1364, Fairfax, VA, 22038-1364, US

(73) Assignee: Inventec Appliances Corp.

(21) Appl. No.: 11/979,053

(22) Filed: Oct. 30, 2007

(30) Foreign Application Priority Data
Dec. 12, 2006 (TW) 95146517

(51) Int. Cl. G08B 21/00

(52) U.S. Cl. 340/664

(57) ABSTRACT

An over-current alerting circuit used in a hand held device includes a current sensor module, a photo sensor module and an alerting module. The current sensor module is used for sensing a loading current of the hand held device and outputting a photo signal according to the intensity of the loading current. The photo sensor module is used for generating a driving signal when the intensity of the photo signal is higher than a predetermined intensity. The alerting module is used for performing an alerting action after the driving signal is received. In addition, an over-current alerting method is also disclosed herein.

### RELATED APPLICATIONS

This application claims priority to Taiwan Application Serial Number 95146517, filed Dec. 12, 2006, which is herein incorporated by reference.

### BACKGROUND

1. Field of Invention

The present invention relates to an over-current alerting device and a method thereof. More particularly, the present invention relates to an over-current alerting circuit of a hand held device and a method thereof.

2. Description of Related Art

As the progress of modern technology, compact sized and high-precision electronic products have become the major trend of new electronic products. These compact and mobile devices (e.g. PDA, personal digital assistant) are essentially designed on the basis of “hand held” concept.

However, transient loading current might be too high and lead to possible damage due to some unexpected conditions. There is not any alerting device for alerting over current in conventional hand held devices, so user can only feel the high temperature resulted from over current, but integrated circuits in the hand held device might already be damaged.

Therefore, an over-current alerting circuit is desirable for both hand held manufacturers and users to solve the problem mentioned above.

### SUMMARY

According to one embodiment of the present invention, an over-current alerting circuit used in a hand held device comprises a current sensor module, a photo sensor module and an alerting module. The current sensor module is used for sensing a loading current of the hand held device and outputting a photo signal according to the intensity of the loading current. The photo sensor module is used for generating a driving signal when the intensity of the photo signal is higher than a predetermined intensity. The alerting module is used for performing an alerting action after the driving signal is received.

According to another embodiment of the present invention, an over-current alerting method used in a hand held device is provided, comprising following steps:

(1) sensing a loading current of the hand held device;

(2) outputting a photo signal according to the intensity of the loading current; and

(3) performing an alerting action when the intensity of the photo signal is higher than a predetermined intensity.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a function block diagram of an over-current alerting circuit according to one embodiment of the present invention;

FIG. 2 is a circuit diagram of the current sensor module in FIG. 1;

FIG. 3 is a circuit diagram of the photo sensor module in FIG. 1;

FIG. 4 is a circuit diagram of the alerting module in FIG. 1;

FIG. 5 is a circuit diagram of the alerting module according to another embodiment of the present invention; and

FIG. 6 is a flow chart of an over-current alerting method according to yet another embodiment of the present invention.

### DETAILED DESCRIPTION

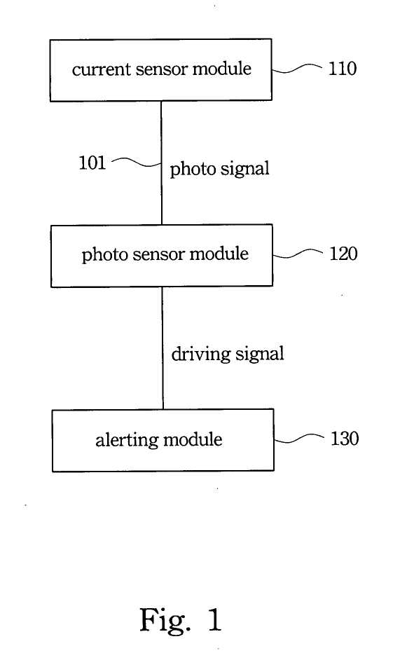

Refer to FIG. 1, FIG. 1 is a function block diagram of an over-current alerting circuit according to one embodiment of the present invention, an over-current alerting circuit used in a hand held device comprises a current sensor module 110, a photo sensor module 120 and an alerting module 130. The current sensor module 110 is used for sensing a loading current of the hand held device and outputting a photo signal according to the intensity of the loading current. The photo sensor module 120 is used for generating a driving signal when the intensity of the photo signal is higher than a predetermined intensity. The alerting module 130 is used for performing an alerting action after the driving signal is received.

The signal transmitted from the current sensor module 110 to the photo sensor module 120 is a photo signal. Therefore, the over-current alerting circuit of this embodiment can further comprise an optical pipe 101 connected between the current sensor module 110 and the photo sensor module 120 for transmitting the photo signal to the photo sensor module 120. However, the device connected between the current sensor module 110 and the photo sensor module 120 is not necessary to be an optical pipe. Any proper device which is able to transmit photo signal to the photo sensor module 120 is acceptable.

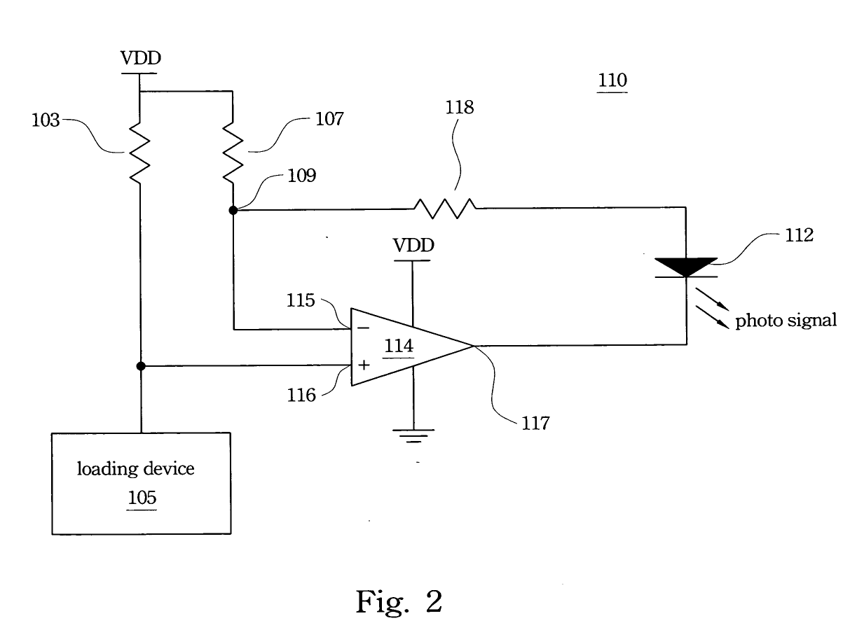

Refer to FIG. 2, FIG. 2 is a circuit diagram of the current sensor module 110 in FIG. 1, the current sensor module 110 can comprise a light emitting diode 112 for generating the photo signal.

More specifically, the current sensor module 110 of this embodiment can further comprise an operational amplifier 114, the operational amplifier 114 comprises a positive input 116, a negative input 115 and an output 117. The positive input 116 is used for inputting the loading current flowing through the resistor 103 and toward the load device 105. The negative input 115 is connected to an anode of the light emitting diode 112 through a node 109. The output 117 is connected to a cathode of the light emitting diode 112. Due to the characteristics of the operational amplifier 114, the voltage at the positive input 116 and the voltage at the negative input 115 are identical. Once if the loading current flowing through the resistor 103 increases, the current flowing through the resistor 107 also increases, the intensity of the light generated by the light emitting diode 112 is also increased as the loading current increases. In other words, the intensity of the photo signal increases as the loading current increases. Therefore, user is able to be aware the change of the loading current by observing the intensity change of the photo signal.

Furthermore, the current sensor module 110 shown in FIG. 2 can comprise a current-limiting resistor 118 connected between the node 109 and the anode of the light emitting diode 112, in order to prevent from being damaged by over-current.

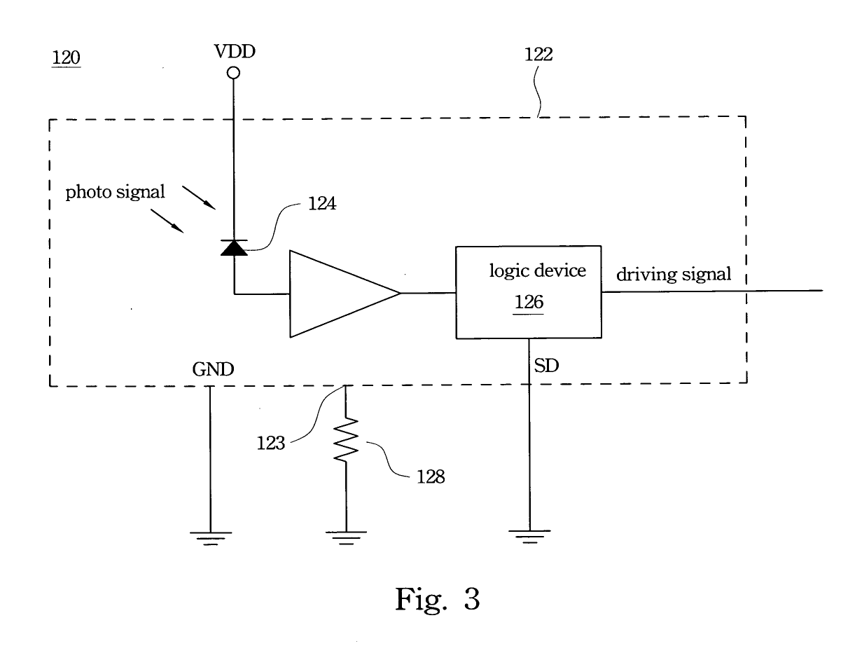

Refer to FIG. 3, FIG. 3 is a circuit diagram of the photo sensor module 120 in FIG. 1, the photo sensor module 120 can comprise a photo sensor chip 122. The photo sensor chip 122 can comprise a photo sensor device 124 and a logic device 126. The photo sensor device 124 is used for receiving the photo signal. The logic device 126 connected with the photo sensor device 124 is used for generating the driving signal when the intensity of the photo signal is higher than the predetermined intensity. The intensity of the photo signal increases as the loading current increases. Once if the intensity of the photo signal is higher than the predetermined intensity, meaning the loading current is higher than the safety current of the load device, the photo sensor module will therefore generate a driving signal to drive the alerting module.

The photo sensor chip 122 of FIG. 3 can further comprise a resistance setting end 123. The photo sensor module 120 can further comprise a variable resistor 128 connected to the resistance setting end 123. More specifically, the variable resistor 128 is used for adjusting the above mentioned predetermined intensity, so user can adjust the resistance of the resistor according to the safety current of the load device.

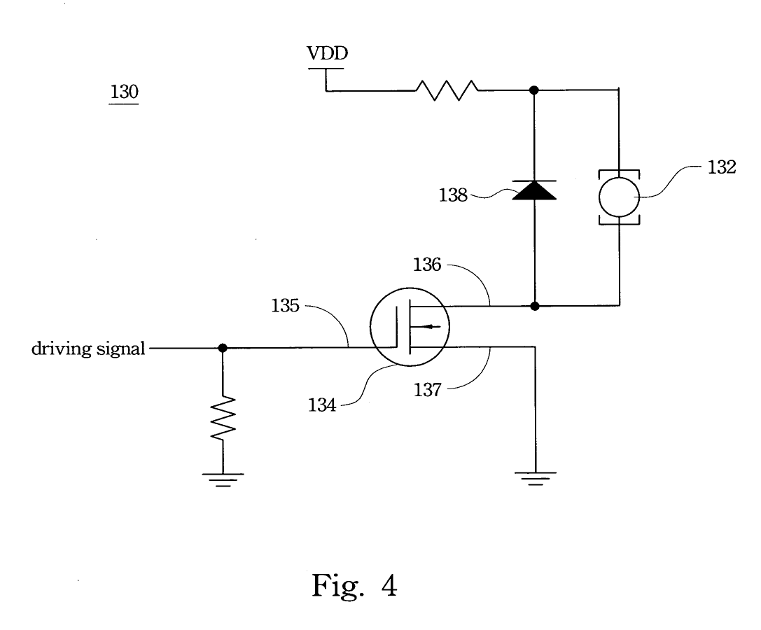

Refer to FIG. 4, FIG. 4 is a circuit diagram of the alerting module 130 in FIG. 1, the alerting module 130 can comprise a vibration motor 132 for generating vibration after receiving the driving signal. Therefore, user is able to be aware that the loading current is higher than the safety current by the vibration.

More specifically, the alerting module 130 of FIG. 4 can further comprise a switch device 134. The switch device 134 is connected with the vibration motor 132 and the photo sensor module for turning on the vibration motor 132 after receiving the driving signal. In this embodiment, the above mentioned switch device 134 can be a transistor, the gate 135 of the transistor is connected to the photo sensor module 120, the drain 136 of the transistor is connected to the vibration motor 132 and the source 137 of the transistor is connected to a ground voltage. Once if the intensity of the driving signal is higher than the threshold voltage of the transistor, the source 137 and the drain 136 of the transistor will be electrically connected and the vibration motor 132 will thus be driven.

Furthermore, the alerting module 130 of the embodiment can comprise a diode 138 connected with vibration motor 132 in parallel for preventing the vibration motor 132 from being damaged by sudden voltage increase.

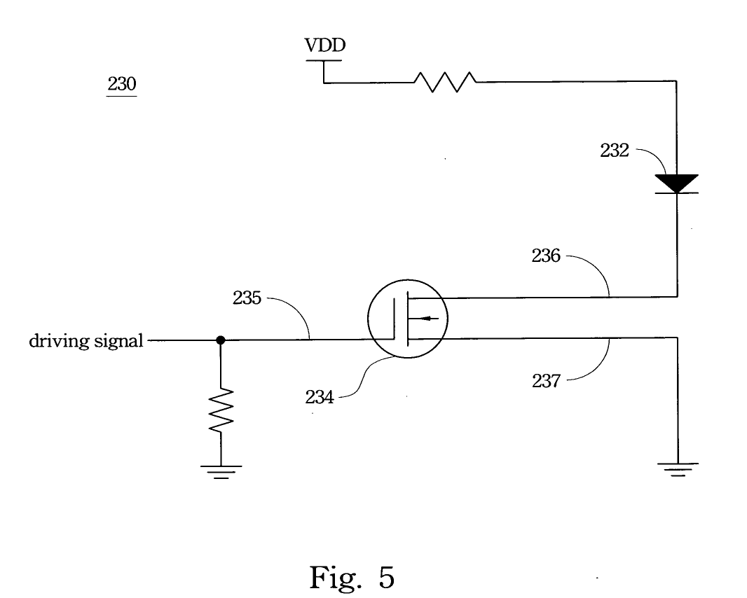

Refer to FIG. 5, FIG. 5 is a circuit diagram of the alerting module according to another embodiment of the present invention, the alerting module 230 can comprise a light emitting diode 232. The light emitting diode 232 is used for generating light after receiving the driving signal. User is able to be aware that the loading current is higher than the safety current of the load device by the light generated by the light emitting diode 232. In the embodiment, the above mentioned light emitting diode 232 can be a red light emitting diode. It is easily understood that the present invention is not limited in red light emitting diode, it can be light emitting diode of other colors, or even other types of illuminating devices.

More specifically, the alerting module 230 of FIG. 5 can further comprise a switch device 234. The switch device 234 is connected with the light emitting diode 232 and the photo sensor module for turning on the light emitting diode 232 after receiving the driving signal. In this embodiment, the above mentioned switch device 234 can be a transistor, the gate 235 of the transistor is connected to the photo sensor module, the drain 236 of the transistor is connected to the light emitting diode 232 and the source 237 of the transistor is connected to a ground voltage. Once if the intensity of the driving signal is higher than the threshold voltage of the transistor, the source 237 and the drain 236 of the transistor will be electrically connected and the light emitting diode 232 will thus be turned on.

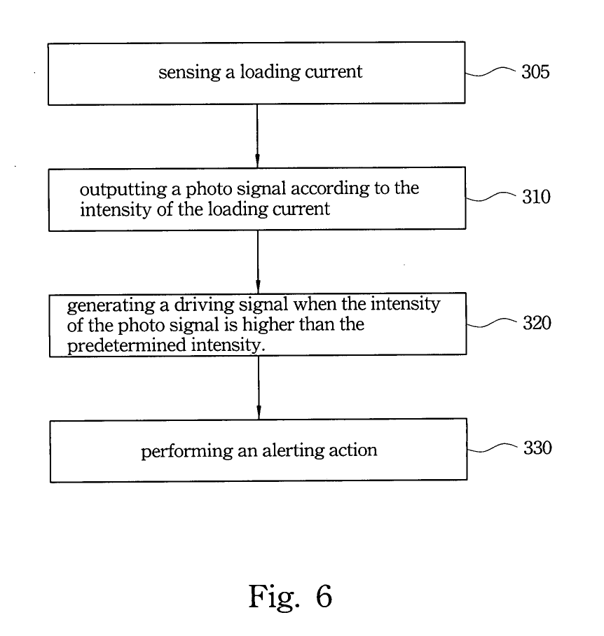

Refer to FIG. 6, FIG. 6 is a flow chart of an over-current alerting method according to yet another embodiment of the present invention, an over-current alerting method used in a hand held device, comprising following steps:

(1) sensing a loading current (step 305) of the hand held device;

(2) outputting a photo signal according to the intensity of the loading current (step 310); and

(3) performing an alerting action (step 330) when the intensity of the photo signal is higher than a predetermined intensity.

More specifically, the above mentioned alerting action can be illumination (i.e. generating light) or vibration. It is easily understood that the other alerting action (e.g. ring tone) can also be selected.

Furthermore, the over-current alerting method can further comprise the following step:

(2.1) generating a driving signal when the intensity of the photo signal is higher than the predetermined intensity (320).

Therefore, the alerting action can be performed after the driving signal is generated.

It is easily understood that the above mentioned hand held device can be PDA, electronic dictionary, digital camera, mobile phone or other hand held devices. Those skilled in the art should be able to select proper method which is not limited in the above embodiments.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An over-current alerting circuit used in a hand held device, comprising:
a current sensor module for sensing a loading current of the hand held device and outputting a photo signal according to the intensity of the loading current;
a photo sensor module for generating a driving signal when the intensity of the photo signal is higher than a predetermined intensity; and
an alerting module for performing an alerting action after the driving signal is received.

2. The over-current alerting circuit of claim 1, further comprising an optical pipe connected between the current sensor module and the photo sensor module for transmitting the photo signal to the photo sensor module.

3. The over-current alerting circuit of claim 1, wherein the current sensor module comprises a light emitting diode for generating the photo signal.

4. The over-current alerting circuit of claim 3, wherein the current sensor module comprises an operational amplifier, and the operational amplifier comprises:
a positive input for inputting the loading current;
a negative input connected to an anode of the light emitting diode through a node; and
an output connected to a cathode of the light emitting diode.

5. The over-current alerting circuit of claim 4, wherein the current sensor module comprises a current-limiting resistor connected between the node and the anode of the light emitting diode.

6. The over-current alerting circuit of claim 1, wherein the photo sensor module comprises a photo sensor chip, and the photo sensor chip comprises:
a photo sensor device for receiving the photo signal; and
a logic device connected with the photo sensor device for generating the driving signal when the intensity of the photo signal is higher than the predetermined intensity.

7. The over-current alerting circuit of claim 6, wherein the photo sensor chip comprises a resistance setting end, and the photo sensor module comprises a variable resistor connected to the resistance setting end for adjusting the predetermined intensity.

8. The over-current alerting circuit of claim 1, wherein the alerting module comprises a vibration motor for generating a vibration after receiving the driving signal.

9. The over-current alerting circuit of claim 8, wherein the alerting module comprises a switch device connected with the vibration motor and the photo sensor module for turning on the vibration motor after receiving the driving signal.

10. The over-current alerting circuit of claim 9, wherein the switch device is a transistor comprising:
a gate connected to the photo sensor module;
a drain connected to the vibration motor; and
a source connected to a ground voltage.

11. The over-current alerting circuit of claim 8, wherein the alerting module comprises a diode connected with the vibration motor in parallel.

12. The over-current alerting circuit of claim 1, wherein the alerting module comprises a light emitting diode for generating a light after receiving the driving signal.

13. The over-current alerting circuit of claim 12, wherein the light emitting diode is a red light emitting diode.

14. The over-current alerting circuit of claim 12, wherein the alerting module comprises a switch device connected with the light emitting diode and the photo sensor module for turning on the light emitting diode after receiving the driving signal.

15. The over-current alerting circuit of claim 14, wherein the switch device is a transistor comprising:
a gate connected to the photo sensor module;
a drain connected to the light emitting diode; and
a source connected to a ground voltage.

16. An over-current alerting method used in a hand held device, comprising:
sensing a loading current of the hand held device;
outputting a photo signal according to the intensity of the loading current; and
performing an alerting action when the intensity of the photo signal is higher than a predetermined intensity.

17. The over-current alerting method of claim 16, wherein performing the alerting action comprises generating a light.

18. The over-current alerting method of claim 16, wherein performing the alerting action comprises generating a vibration.

19. The over-current alerting method of claim 16, further comprising:
generating a driving signal when the intensity of the photo signal is higher than the predetermined intensity.

20. The over-current alerting method of claim 19, wherein performing the alerting action is proceeded after the driving signal is generated.
